(19) United States
(12) Patent Application Publication
(10) Pub. No.: US 2004/0243426 A1
(43) Pub. Date: Dec. 2, 2004

(54) Method for issuing/acquiring key information of collection/delivery box

(76) Inventor: Hideo Hashimoto, Uji-shi (JP)

Correspondence Address: BIRCH STEWART KOLASCH & BIRCH, PO BOX 747, FALLS CHURCH, VA, 22040-0747, US

(21) Appl. No.: 10/487,677

(22) PCT Filed: Sep. 5, 2002
(86) PCT No.: PCT/JP02/09037

(30) Foreign Application Priority Data
Sep. 6, 2001 (JP) 2001-270612

(51) Int. Cl. G06F 17/60

(52) U.S. Cl. 705/1

(57) ABSTRACT

A method for obtaining and issuing key information of a collection/delivery box device, which enables issuance of high security key information to be used for releasing a lock on the collection/delivery box device and obtainment by a collection/delivery company of the key information with the high security being ensured is provided.

A sender gives a delivery notice of an article to a receiver. The receiver or the sender issues key information. The key information is given to the collection/delivery company in the case where the receiver issues the key information. The key information is given to the receiver and the collection/delivery company in the case where the sender issues the key information. At least one of the receiver, the sender, and the collection/delivery company performs the issuance or the communication of the key information by using a mobile communication device. The mobile communication device is capable of close wireless communication of the key information with the collection/delivery box device.

### TECHNICAL FIELD

The present invention relates to a collection/delivery box device called “home delivery box”. More specifically, the invention relates to a method of handling key information for releasing a lock on a door through which articles are transferred into and from the collection/delivery box device.

### BACKGROUND ART

For instance, in a home delivery laundry service, a client orders a laundry company a service of cleaning an article such as a clothing item and a bedding item by using a communication means such as telephone and e-mail. A collection/delivery company which is entrusted by the laundry company serves to collect the article at a home of the client at a date and a time specified by the client and to deliver the article after cleaning to the client's home at a date and a time specified by the client. The client can specify a neighborhood convenience store or the like as a place of the collection and the delivery. Thus, the article is collected and delivered by the collection/delivery company at the client's convenience.

In the conventional delivery/collection method, in the case where a client specifies a client's home as a place of delivery/collection, the client is subject to time constraints because the client has to be at home at predetermined collection/delivery times. If the client is absent from home at the delivery time or the collection time, a collection/delivery company has to post an absentee delivery/collection notice in a client's mailbox. Though the collection/delivery company may be allowed to leave the article with one of neighbors of the client, but the collection/delivery company rarely leaves the article nowadays because it often happens that the neighbors are reluctant to handle the deposited article.

In the case where a convenience store is specified as the collection/delivery place, the client is not subject to the time constraints and the collection/delivery company is free from worrying whether the client is at home or not. In turn, the client has to go to the collection/delivery place to fetch the article. The above drawbacks are not limited to the home delivery laundry service and can be caused in general home delivery services. In view of the above, an electronic lock type collection/delivery box device called “home delivery box” has been proposed and has practically been used mainly as a common locker in a multiple housing. Representative examples of the collection/delivery box device are as follows.

(1) The collection/delivery box device disclosed in Japanese Unexamined Patent Publication No. 5-147694, Japanese Unexamined Patent Publication No. 7-293068, Japanese Unexamined Patent Publication No. 10-127470, and so forth. The collection/delivery box device of this type is provided at an entrance of a multiple housing or for each of dwellings, for example. A collection/delivery company releases the lock on a door of the collection/delivery box device for the purpose of collecting an article contained in the collection/delivery box device or delivering an article sent from a sender. When the collection/delivery company manually inputs key information using an input device with ten-key or the like, the lock on the door of the collection/delivery box device is released.

(2) The collection/delivery box device disclosed in Japanese Unexamined Patent Publication No. 5-147694, Japanese Unexamined Patent Publication No. 10-127470, and so forth. The collection/delivery box device of this type uses a room number or a combination of the room number and a number specifying a collection/delivery company as key information.

(3) The collection/delivery box device disclosed in Japanese Unexamined Patent Publication No. 5-287943, Japanese Unexamined Patent Publication No. 7-237696, Japanese Unexamined Patent Publication No. 10-127470, Japanese Unexamined Patent Publication No. 2000-17911, and so forth. With the collection/delivery box device of this type, a collection/delivery company uses a magnetic card to access the collection/delivery box device. Information specifying the collection/delivery company is recorded on the magnetic card.

(4) The collection/delivery box device disclosed in Japanese Unexamined Patent Publication No. 9-8925 and so forth. The collection/delivery box device of this type is provided with a camera, and the camera picks up an image of collection/delivery personnel. A client confirms the pickup image of the collection/delivery personnel by way of an interphone, a mobile communication device, or the like to perform remote lock release operation.

With the collection/delivery box device (1), in the case where an owner of the collection/delivery box device releases the lock, the owner uses the key information which is known to nobody but the owner. However, when the owner allows a third party such as the collection/delivery company to release the lock on the door, it is necessary to inform the collection/delivery company of the key information anyhow.

The collection/delivery box device (2) entails the risk of a key information leakage after the collection/delivery company obtains the key information. The collection/delivery company can release the lock of the collection/delivery box device anytime because the room number and the number specifying the collection/delivery company are fixed numbers, which is problematic.

With the collection/delivery box device (3), it is possible to avoid the risk that the general public accesses the collection/delivery box device. However, since the collection/delivery company possesses the magnetic card on which the stationary information is recorded, security is not ensured if plural magnetic cards are issued. Further, in the multiple housing, it is necessary to issue a new magnetic card every removal of the dwellers in order to maintain the security.

The collection/delivery box device (4) does not require the key information. However, it is difficult for the client to distinguish between false collection/delivery personnel and true collection/delivery personnel based on the pickup image, and the client has to wait on every visit of the collection/delivery personnel.

The present invention has been accomplished in view of the above-mentioned circumstances, and an object thereof is to provide a method of issuing and obtaining key information of a delivery/collection box device, which enables:

(1) to realize issuance of key information which is used for releasing a lock on a collection/delivery box device and is high in security as well as obtainment of the key information by a collection/delivery company with the high security being ensured and without troubling a client and the collection/delivery company;

(2) to obviate necessity of the client's being at home for collection/delivery and to set a place of delivery as close as possible to the client's home; and

(3) to free the delivery/collection company from worrying whether the client is at home or not.

In this specification, the person using the collection/delivery box device for the purposes other than the substantial collection/delivery works is referred to as “client”, and the client may be a sender or a receiver as described later in this specification. Also, the client does not necessarily possess the collection/delivery box, and the collection/delivery box can be used as a shared one.

### DISCLOSURE OF THE INVENTION

In order to solve the above-described problems, according to the present invention, there is provided a method of issuing and obtaining key information of a collection/delivery box device, which enables a collection/delivery company to obtain electronic key information to be used for releasing a lock on a door of a deliver/collection box device of a receiver so that the collection/delivery company can put in the collection/delivery box device an article sent in accordance with a delivery request made by a sender, the method comprising the following steps.

(1) The sender gives a notice of a delivery of the article to the receiver, and the receiver issues the key information.

(2) The key information is given to the collection/delivery company when the receiver issues the key information, while the key information is given to the receiver and the collection/delivery company when the sender issues the key information.

(3) At least one of the receiver, the sender, and the collection/delivery company issues or gives the key information by using a mobile communication device capable of close wireless communication of the key information.

Further, in order to solve the problems, according to the present invention, there is provided a method of issuing and obtaining key information of a collection/delivery box device, which enables a collection/delivery company to obtain electronic key information to be used for releasing a lock on a door of a deliver/collection box device of a receiver so that the collection/delivery company can put in the collection/delivery box device an article sent in accordance with a delivery request made by a sender, the method comprising the following steps.

(1) The collection/delivery company who has received the delivery request of the article from the sender gives a notice of a delivery of the article to the receiver.

(2) The key information is given to the receiver and the collection/delivery company when the sender issues the key information, while the key information is given to the receiver when the collection/delivery company issues the key information.

(3) At least one of the receiver, the sender, and the collection/delivery company issues or gives the key information by using a mobile communication device capable of close wireless communication of the key information.

The collection/delivery company in this invention is not limited to a company which specializes in collection/delivery, and the collection/delivery company may be a laundry company performing collection/delivery of cleaning items as a part of its home delivery laundry service.

The mobile communication device in this invention is not limited to a PDA (personal digital assistant), and any handy communication devices are usable as the mobile communication device. For example, a network compatible cellular phone is used as the mobile communication device.

The collection/delivery box device is located at a place which is physically accessible for the collection/delivery company so as not to cause time constraints on the client at the time of the collection/delivery. Preferably, the collection/delivery box device is located in front of an entrance of a home of the client or the like. Thus, labor of the client of going to and returning from the collection/delivery place is largely reduced. The collection/delivery box device may be located at another place (preferably outside the home) in a plot of the client's dwelling. In a multiple housing, the collection/delivery box device is located on an estate in common of the multiple housing. The labor of the client going to and returning from the collection/delivery box device is diminished with a reduction in distance from the location of the collection/delivery box device to the client's dwelling.

Use of the collection/delivery box device is not limited to the collection/delivery by home delivery company and is applicable to collection/delivery of mail matters.

In the invention, the collection/delivery company who releases the lock on the collection/delivery box device must ultimately obtain the key information (or information relating to the key information, which will be described later in this specification) that the receiver has stored in the collection/delivery box device. In the invention, a third party who sends the article is the sender, the client who receives the article is the receiver, and the sender and the receiver may exchange positions with each other. Each of the sender and the receiver can possess and use the collection/delivery box device.

Hereinafter, an outline of issuance of the key information of the collection/delivery box device and obtainment of the key information by the collection/delivery company of will be described.

As to the home delivery, the client voluntarily asks the collection/delivery company for collection/delivery from/to the collection/delivery box device in some cases, and the third party requests the collection/delivery company to deliver a specific article to the client in other cases. For instance, the client may order merchandise from a mail order company, and an acquaintance of the client may send a gift to the client using a home-delivery service. In the above cases, it is difficult for the collection/delivery company to obtain the key information for unlocking the collection/delivery box device from the client through direct communication with the client when the client is not informed of the delivery of article from the third party.

As described in the foregoing, in the case where the receiver stores the key information in the collection/delivery box device, the collection/delivery company must ultimately obtain the key information as information for releasing the lock. Therefore, both of the receiver and the collection/delivery company hold certain key information. Such key information is not limited to that issued by the receiver or the collection/delivery company, and the sender may issue key information.

When the receiver issues the key information, the issued key information is stored in the collection/delivery box device. The key information is given to the collection/delivery company directly or indirectly via the sender.

When the sender issues the key information, the issued key information is given to the receiver directly or indirectly via the collection/delivery company to be stored in the collection/delivery box device. The key information is given to the collection/delivery company directly or indirectly via the receiver, and the collection/delivery company uses the key information as key information for releasing the lock on the collection/delivery box device.

When the collection/delivery company issues the key information, the issued key information is used as key information for releasing the lock on the collection/delivery box device. The key information is given to the receiver directly or indirectly via the sender.

Though reliability of the issuance of key information is maintained when the receiver issues the key information, reliability of the issuance of key information is in question when the sender or the collection/delivery company issues the key information. In other words, under the circumstances where anybody can issue the key information, a so-called “falsely posing” might occur to fail in ensuring security. Accordingly, the sender or the collection/delivery company gives a delivery notice including highly reliable information directly or indirectly to the receiver. Examples of the highly reliable information are information identifying the sender or information identifying the collection/delivery company. Thus, the falsely posing as the sender or the collection/delivery company is prevented.

In the case where the sender directly gives the delivery notice to the receiver, the receiver has only to be informed of the sender's name provided that the sender is one of the receiver's acquaintances. More specifically, e-mail or the like including a name by which the sender is specified and a mail address or the like may be used as the delivery notice. Of course, the delivery notice is not limited to the e-mail in this invention, and it is possible to use other means as the delivery notice so far as they contain information for specifying the sender.

In the case of ordering merchandise from a mail order company, the receiver does not personally know the sender. In such case, too, e-mail can be used as the delivery notice so far as it contains the name of the sender because the receiver ordinarily remembers the mail order that she/he gave.

In the case where the collection/delivery company gives the delivery notice, the collection/delivery company may include information for specifying the collection/delivery company, such as a company name, in the delivery notice if the collection/delivery company is well known. However, such delivery notice is not effective for preventing the falsely posing. Therefore, the collection/delivery company includes identification for proving that the collection/delivery company is true and is requested of the home delivery to the receiver in the delivery notice. The identification of the collection/delivery company is made by a predetermined authentication organization (hereinafter referred to as “authentication organization” when so required). The authentication organization issues the identification for proving that the collection/delivery company is true. The identification is not limited to the collection/delivery company and can be applied to the sender who is subject to the falsely posing.

A third party, for example, may establish the authentication organization and it is desirable that the authentication organization is socially recognized. The authentication organization can be structured as a web site operated by the third party. Therefore, the authentication organization is not necessarily operated by a substantial third party and can be operated by the collection/delivery company. In short, it is sufficient that the identification information issued by the web site operating as the authentication organization gives a certain degree of safety to the receiver.

More specifically, the authentication organization is structured as something like an authentication station particularly as an authentication station in accordance with the SET (Secure Electronic Transactions) system. Though a requirement of registration is included in the above-described identification method, the registration may be used temporarily for one collection/delivery. Though identification of the receiver is not essential in the invention, the receiver may be subject to identification when the sender and the collection/delivery company involved in the communication with the receiver request the receiver's identification.

Provided that the web site has sufficient reliability, the operation will be as follows. For instance, the collection/delivery company opens a web site for delivery request. A sender's delivery request received by the web site is made open to public and, simultaneously, the receiver is notified of the delivery request. This notification is the delivery notice. The web site may be constituted in such a fashion that the receiver or the web site issues key information when the receiver accesses the web site.

Thus, single key information (or personal identification number) may be used as the key information of which the reliability has been ensured in the above-described manner. In this case, the key information is communicated based on a so-called common key scheme. In turn, two types of key information may be used as the reliable key information. In this case, the key information is communicated based on a so-called asymmetric key scheme. In the case of employing the asymmetric key scheme, an open key for encoding and a secret key for decoding are generally used.

In actual operation, information relating to the delivery request might accompany the information specifying the sender and the information specifying the collection/delivery company. From the standpoint of privacy protection, the information specifying the sender and the information specifying the collection/delivery company is transmitted after being encoded. Thus, securities of the information specifying the sender and the information specifying the collection/delivery company are ensured.

In this case, the secret key may be used for encoding, while the open key may be used for decoding. The receiver is allowed to obtain the open key, while the collection/delivery company is allowed to obtain the secret key which has been obtained via the sender. The collection/delivery company uses the secret key to encode the information specifying at least one of the sender and the collection/delivery company, the information relating to the delivery request, and so forth and then transmits the encoded information to the receiver as the delivery notice. The receiver decodes the delivery notice received from the collection/delivery company using the open key. When the delivery notice thus decoded is decipherable, the lock on the collection/delivery box device is released. In the case where the lock on the collection/delivery box device is released based not only on the decipherable decoded information but also on contents of the deciphered information, further improvement in security is expected.

As described in the foregoing, in the invention, the key information is not limited to the key itself such as the electronic personal identification number and the electronic key and includes the information encoded by the use of the key.

In the invention, the communication among the receiver, the sender, and the collection/delivery company may preferably be conducted by way of signal communication in view of easiness of communication of the electronic key information, security of the information to be communicated, and easiness of processing the key information and other information to be communicated.

It is desirable that each of the receiver, the sender, and the collection/delivery company has a device capable of the above information communication and performs the above-described series of processing. However, the sender and the receiver are not required to posses a special signal communication device if only they have a device which enables the use of the collection/delivery box device. Examples of the device capable of the above information communication are infrared ray devices and mobile communication devices suitable for close communication such as Bluetooth. Thus, the security problem in the communication with the collection/delivery box device, such as leakage of communication contents, is minimized.

In this specification, “receiver” means a receiver or the receiver and a communication device used by the receiver; “sender” means a sender or the sender and a communication device used by the sender; “collection/delivery company” means a collection/delivery company or the collection/delivery company and a communication device used by the collection/delivery company; and “authentication organization” means an authentication organization or the authentication organization and a communication device used by the authentication organization.

According to the method of issuing and obtaining key information of a collection/delivery box device of the invention, the digitized key information issued by the collection/delivery box device or a device such as a home server and a mobile communication device is easily communicated to a specific collection/delivery company. Since the issued key information has been signalized to be in a communicable for form and can be issued to the collection/delivery company with a work of a transfer of an article into and from the collection/delivery box device being set as one unit, the security of the communication of the key information is remarkably high.

Since the collection/delivery box device is capable of close wireless communication of the electronic key information with the mobile communication devices, the receiver or the collection/delivery company uses his/her mobile communication device to perform the lock releasing operation in the vicinity of the collection/delivery box device, thereby eliminating necessity of a stationary communication device. Particularly, since the receiver can perform the key information storage operation, the lock release operation, and so forth by the use of the mobile communication device, the receiver can easily handle the collection/delivery box device immediately before leaving home or when returning home. Likewise, since the collection/delivery company performs the lock release operation and so forth by the use of the mobile communication device, the collection/delivery company uses the collection/delivery box device easily without a physical interface for communication during the collection/delivery. When the client and the collection/delivery company use the key information, they do not have to concern over the contents of key information and are free from erroneous input because input operation using a ten-key or the like is unnecessary. Thus, it is remarkably easy for the client and the collection/delivery company to use the collection/delivery box device.

As used herein, the collection/delivery company, the client, the sender, the receiver, and the authentication organization may also be trustees (committees) who are entrusted by them in some cases. Accordingly, the collection/delivery company, the client, the sender, the receiver, and the authentication organization may also be communication devices used by the trustees (committees).

### BRIEF DESCRIPTION OF THE DRAWINGS

FIG. 1 is an illustration of a collection/delivery method and a collection/delivery box device according to the present invention.

FIG. 2 is a block diagram showing a structure of the network and constitutions of the home server and the control system of the collection/delivery box device of FIG. 1.

FIG. 3 is a flowchart showing contents of mutual processing performed between the collection/delivery box device and the home server in the collection/delivery method according to the invention.

FIG. 4 is an illustration of an example of a communication device of a server of a client, which is used for operating the collection/delivery box device according to the invention.

FIG. 5 is an illustration of an example of a communication device of a collection/delivery company (particularly collection/delivery personnel at job site) holding key information.

FIG. 6 is an illustration of a circulation of key information of the collection/delivery box when a sender makes a delivery request.

FIG. 7 is an illustration of an example of a circulation of key information of the collection/delivery box when a sender gives a delivery notice to a receiver.

FIG. 8 is an illustration of another example of the circulation of key information of the collection/delivery box when the sender gives a delivery notice to the receiver.

FIG. 9 is an illustration of an example of a circulation of key information of the collection/delivery box when a collection/delivery company gives a delivery notice to the receiver.

FIG. 10 is an illustration of another example of the circulation of key information of the collection/delivery box when the collection/delivery company gives the delivery notice to the receiver.

FIG. 11 is an illustration of an example of a circulation of key information of the collection/delivery box when an authentication organization for preventing falsely posing as the sender or the collection/delivery company is used.

FIG. 12 is an illustration of another example of the circulation of key information of the collection/delivery box when the authentication organization for preventing falsely posing as the sender or the collection/delivery company is used.

FIG. 13 is an illustration of an example of a circulation of key information of the collection/delivery box device when a web site for collection/delivery management (collection/delivery company's web site) is used.

FIG. 14 is an illustration of another example of the circulation of key information of the collection/delivery box device when the web site for collection/delivery management (collection/delivery company's web site) is used.

FIG. 15 is an illustration of an example of a circulation of key information of the collection/delivery box device using the asymmetric key scheme.

FIG. 16 is an illustration of another example of the circulation of key information of the collection/delivery box device using the asymmetric key scheme.

FIG. 17 is an illustration of an example of a utilization of the collection/delivery box device wherein plural collection/delivery box devices are used.

### BEST MODE FOR CARRYING OUT THE INVENTION

Hereinafter, the present invention will be described with reference to the drawings as required based on preferred embodiments.

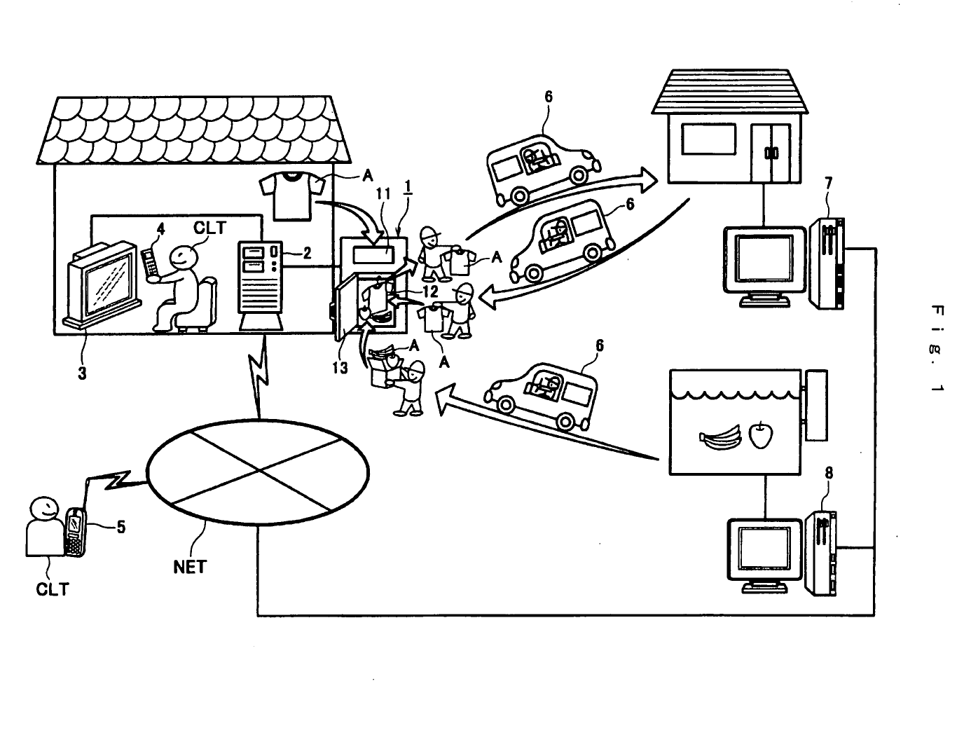

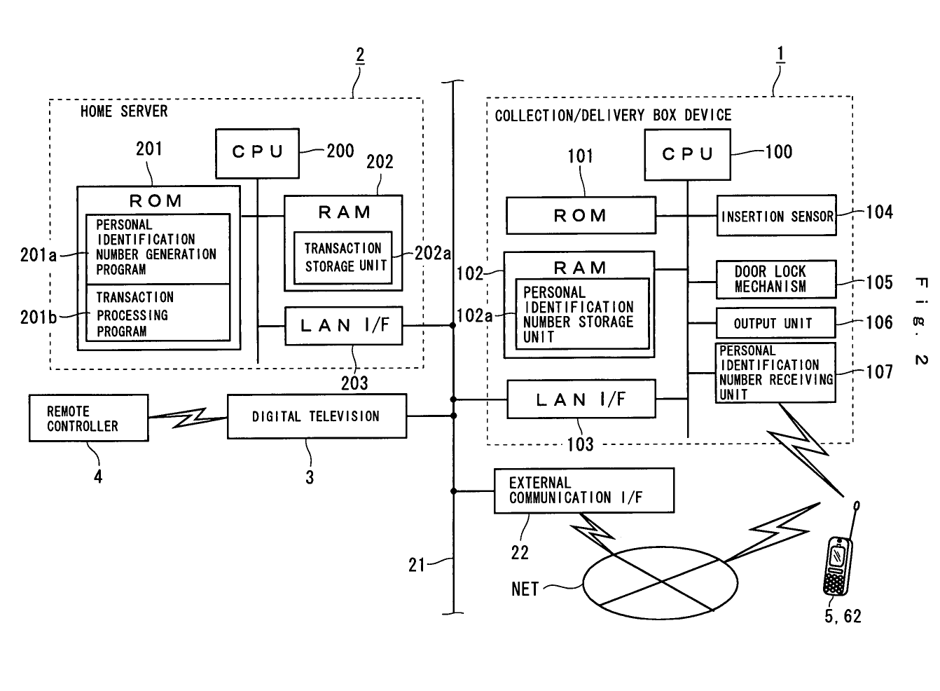

FIG. 1 is an illustration of a collection/delivery method and a collection/delivery box device according to the invention. FIG. 2 is a block diagram showing a structure of the network and constitutions of the home server and the control system of the collection/delivery box device of FIG. 1.

In this embodiment, as shown in FIGS. 1 and 2, a home network which is connected via a LAN 21 is structured around a central home server 2 in a home of a client (upper left in each of the drawings). A communication scheme used for connecting the home network is not limited to the wired LAN shown in the drawings, and other communication schemes are usable. Examples of the other communication schemes are infrared ray communication, wireless LAN communication, and Bluetooth communication. A digital television 3 and a collection delivery box device 1 are connected to the home network. The collection/delivery box device 1 is located outside the client's home and adjacent to the client's home. The location of the collection/delivery box device 1 may preferably be of easy access for the collection/delivery company, such as a front of an entrance.

As shown in FIG. 1, the collection/delivery box device 1 has a slot 11 through which the client CLT inserts an article A, a container 12 for temporally storing the article A inserted through the slot 11, and a door 13 through which the client CLT or the collection/delivery company 6 puts in and takes out the article A. The door 13 is of an electronic lock type.

As shown in FIG. 2, the collection/delivery box device 1 has a CPU 100, a ROM 101, a RAM 102, a LAN interface (LAN I/F) 103, an insertion sensor 104, a door lock mechanism 105, an output unit 106, and a personal identification number receiving unit 107 as its control system.

The CPU 100 controls the components of the collection/delivery box device 1 connected thereto based on a computer program stored in the ROM 101. The ROM 101 stores various computer programs required for operation of the CPU 100. The RAM 102 temporarily stores various series of data generated during the operation of the CPU 100. In this embodiment, a partial area of the RAM 102 is secured as a personal identification number storage unit 102a. The personal identification number storage unit 102a stores a personal identification number for releasing the lock on the door 13. The LAN interface 103 is an interface used for connecting the collection/delivery box device 1 to the LAN 21.

The insertion sensor 104 detects insertion of the article A into the slot 11, and a detection result is given to the CPU 100. The door lock mechanism 105 is an electronic lock mechanism provided on the door 13 and serves to lock and unlock the door 13 in response to instructions from the CPU 100. The output unit 106 is provided with a lamp, a buzzer, a liquid crystal display, and so forth. The personal identification number receiving unit 107 receives the personal identification number externally sent thereto, and a receipt result is given to the CPU 100.

The home server 2 is provided with a CPU 200, a ROM 201, a RAM 202, and a LAN interface (LAN I/F) 203.

The CPU 200 controls the components of the home server 2 connected thereto based on a computer program stored in the ROM 201. The ROM 201 stores various computer programs required for operation of the CPU 200. In this embodiment, the ROM 201 stores a personal identification number generation program 201a and a transaction processing program 201b. The RAM 202 temporarily stores various data generated during the operation of the CPU 200. In this embodiment, a partial region of the ROM 201 is secured as a region for storing various information generated during execution of the transaction processing program 201b. The LAN interface 203 is an interface used for connecting the home server 2 to the LAN 21.

The transaction processing program 201b is activated when a delivery request and a collection request of the article A are input. A demand for the delivery and collection is sent to the client who made the requests and, at the same time, activates the personal identification number generation program 201a. After the activation of the personal identification number generation program 201a, a personal identification number for the demand is issued to be stored in the collection delivery box device 1. The personal identification number generation program 201a is so programmed as to include the personal identification number into the demand.

The home network structured by the LAN 21 is connected to an external network NET via an external communication interface (external communication I/F) 22. The home server 2 accesses internet servers 7 and 8 (see FIG. 1) operated by a laundry company, a super market undertaking prepared food home delivery, and so forth via the network NET. In this embodiment, the network NET means an appropriate network such as the Internet, an extranet, and a dedicated line for network compatible cellular phones.

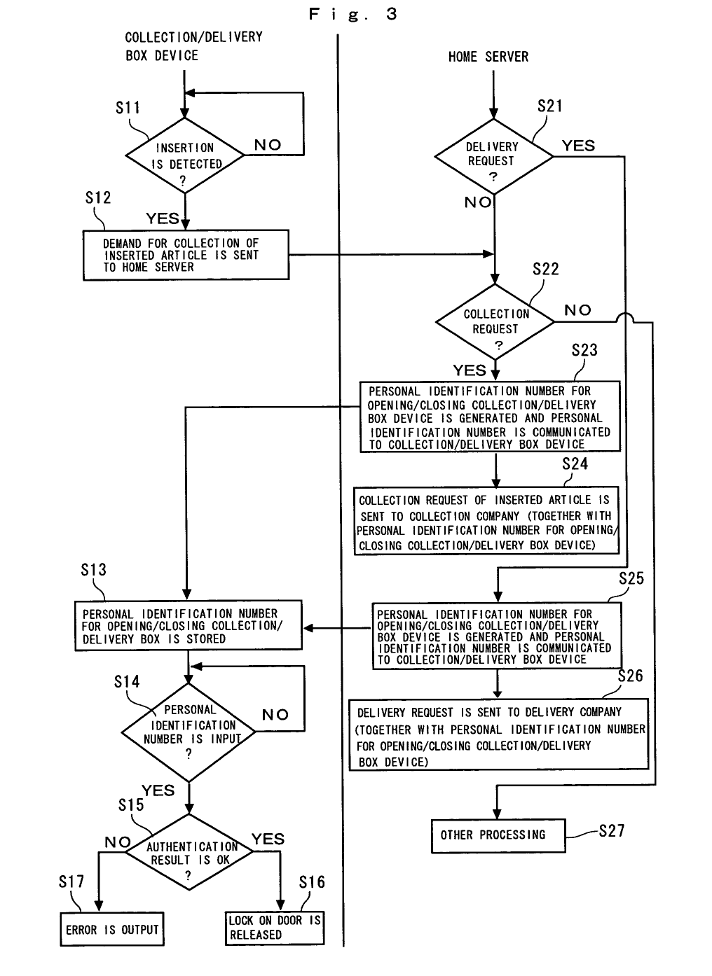

FIG. 3 is a flowchart showing contents of mutual processing performed between the collection/delivery box device 1 and the home server 2 in the case where the client CLT uses the collection/delivery box device 1 to have the article A collected by the collection/delivery company 6. The home server 2 stores, in the transaction storage unit 202a of the RAM 202, the information obtained through the communication with the collection/delivery box device 1 and the information obtained through the communication with the communication device provided outside the home network.

The CPU 100 of the collection/delivery box device 1 monitors insertion of the article A (Step S11) and waits until the insertion is detected by the insertion sensor 104 (NO in Step S11).

When the insertion sensor 104 detects that the client CLT, for example, inserts the article A through the slot 11, the CPU 100 of the collection/delivery box device 1 recognizes the detection (YES in Step S11) to send a demand for collection of the article A by the collection/delivery company 6 to the home server 2 via the LAN interface 103 (Step S12).

The CPU 200 of the home server 2 receives the signal from the collection/delivery box device 1 via the LAN 21. The transaction processing program 201b is activated upon the receipt of the signal, and information of the receipt of the signal from the collection/delivery box device 1 is judged as to whether or not the demand is a collection request (Step S22). When the demand is judged to be the collection request (YES in Step S22), the CPU 200 activates the personal identification number generation program 201a to generate a personal identification number for releasing the lock on the door 13 corresponding to the demand and then informs the collection/delivery box device 1 of the generated personal identification number via the LAN interface 203 (Step S23).

The CPU 200 of the home server 2 sends the collection request corresponding to the demand to the internet server 7 of a collection company (which is in fact the collection/delivery company 6 in this embodiment) via the LAN interface 203 together with the personal identification number. The internet server 7 of the collection company is a window of the collection company (for example, a laundry company).

The CPU 100 of the collection/delivery box device 1 is so set as to instruct the unlocking of the door 13 when a personal identification number externally input thereto is identical with that sent from the home server 2 (Step S13). More specifically, the CPU 100 stores the personal identification number in the personal identification number storage unit 102a of the RAM 102 simultaneously with instructing the door lock mechanism 105 to lock the door 13. Then, the CPU 100 monitors input of the personal identification number by the collection/delivery company 6 (Step S14) and waits for an actual input of the personal identification number (NO in Step S14). Information that the personal identification number has been input is sent from the personal identification number receiving unit 107 to the CPU 100.

When the personal identification number is input (YES in Step S14), the CPU 100 of the collection/delivery box device 1 checks the input personal identification number against the personal identification number stored in the personal identification number storage unit 102a to perform authentication (Step S15). When an authentication result is OK (YES in Step S15), the CPU 100 instructs the door lock mechanism 105 to release the lock on the door 13 (Step S16). When the authentication result is not OK (NO in Step S15), the CPU 100 instructs the output unit 106 to output an error (Step S17). This error output may be realized by setting off the buzzer, lighting the lamp, displaying letters indicating the error, or the like. The output error may be sent to a mobile communication device used by collection/delivery personnel at job site as described later in this specification.

The CPU 200 of the home server 2 monitors a delivery request of an article A to be delivered to the collection/delivery box device 1 (Step S21). The client CLT operates the remote controller 4 to transmit the delivery request to the home server 2 via the digital television 3. Alternatively, the client CLT operates outside the home the mobile communication device 5 such as a network compatible cellular phone and a personal digital assistant (PDA) to transmit the delivery request to the home server 2 via the network NET and the external communication interface 22. Examples of the delivery request are a home delivery order of prepared food to a super market and the like.

The CPU 200 of the home server 2 performs processing of Step S22 when the received information is not a demand for delivery (NO in Step S21). In turn, when the received information is not a demand for collection (NO in Step S22), the CPU 200 of the home server 2 performs other processing (Step S27).

When the received information is the demand for delivery (YES in Step S21), the CPU 200 of the home server 2 activates the personal identification number generation program 201a to generate a personal identification number for releasing the lock on the door 13 corresponding to the demand and then informs the collection/delivery box device 1 of the generated personal identification number via the LAN interface 203 (Step S25).

The CPU 200 of the home server 2 sends a delivery request corresponding to the demand to the internet servers 7 and 8 together with the personal identification number via the LAN interface 203 (Step S26). In this case, the internet servers 7 and 8 serve as windows of delivery companies (which are in fact the collection/delivery company 6 in this embodiment) such as a laundry company and a super market. In turn, the CPU 100 of the collection/delivery box device 1 performs the processing of Steps 13 to 17 depending on the result of Step S25.

Though the collection/delivery box device 1 has been described as the one having the box-like container 12 in this embodiment, the collection/delivery box device 1 may have functions such as incubation and humidification depending on a type of the article A to be contained therein.

Though the home server 2 performs the generation of personal identification number, i.e. the issuance of personal identification number, in this embodiment, the collection/delivery box device 1 may have the personal identification number generation program 201a to issue the personal identification number. Similarly, the client's mobile communication device 5 may have the personal identification number generation program 201a to issue the personal identification number. In this case, the issued personal identification number is directly stored in the collection/delivery box 1.

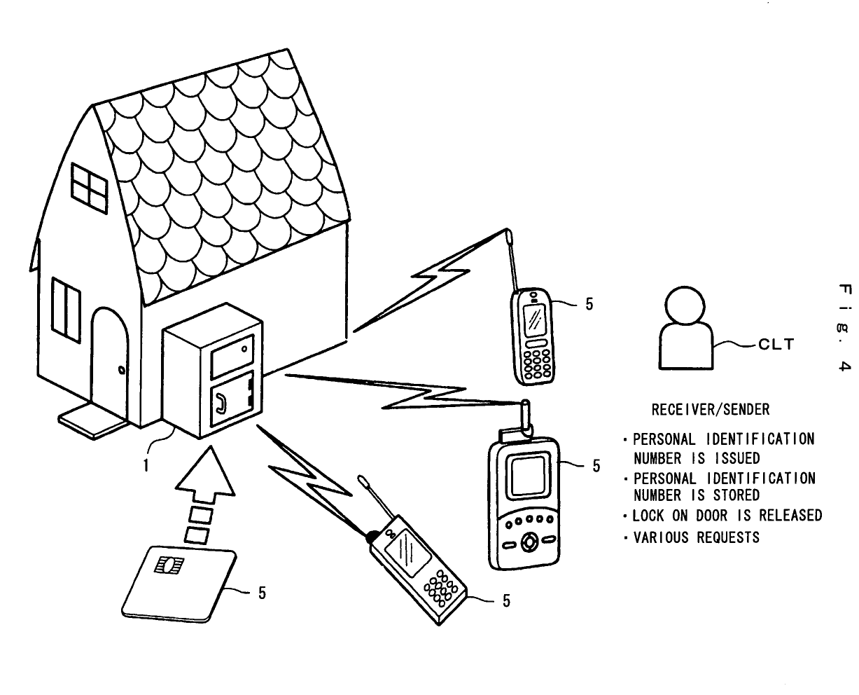

As the mobile communication device 5, mobile communication devices in conformity with various communication schemes may be used. More specifically, as shown in FIG. 4, examples of the mobile communication device 5 are a network compatible cellular phone, a PDA based on the Bluetooth, a cellular phone based on infrared ray communication, a non-contact IC card, and the like. Accordingly, as the personal identification number receiving unit 107 of the collection/delivery box device 1, any one of those which are in conformity with the above communication schemes is used. Each of the mobile communication devices 5 usually has a memory (not shown) for storing a personal identification number and a CPU for executing a computer program such as the personal identification number generation program 201a, which means that any known mobile communication device readily has the function of issuing the personal identification number.

The mobile communication device 5 not only performs the issuance and storage of the personal identification number, but also instructs the collection/delivery box device 1 to release the lock on the door 13 using its communication function. The mobile communication device 5 may be used for making the above-described requests which are in this embodiment made by using the home server 2 and the remote controller 4. In the case where the mobile communication device 5 is used for making the requests, the demands corresponding to the requests (hereinafter referred to as “request information”) are transferred to the home server 2 via the collection/delivery box device 1.

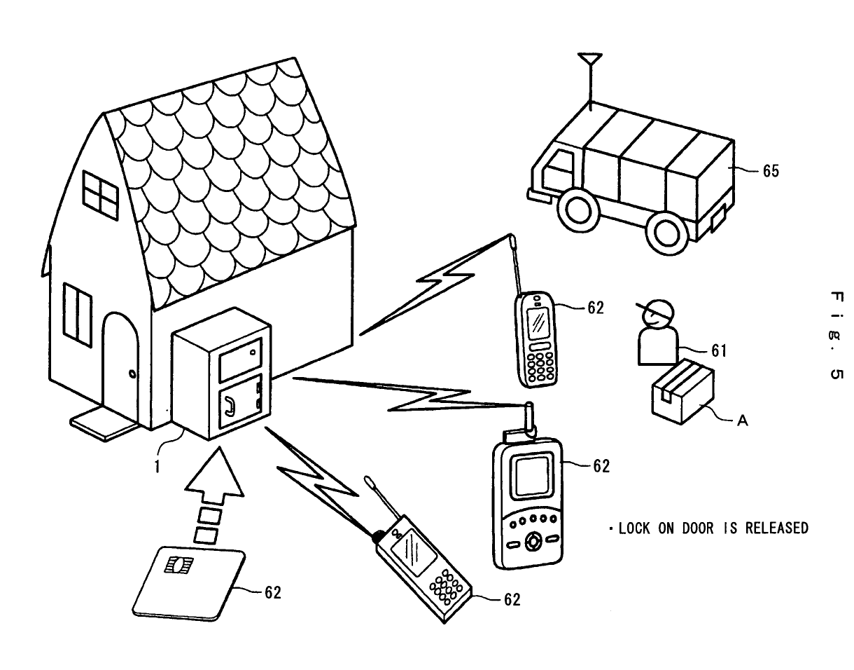

Likewise, as shown in FIG. 5, a mobile communication device 62 used by collection/delivery personnel at job site who actually collects and/or delivers the article A may be used for releasing the lock on the door 13 of the collection/delivery box device 1. In this case, a communication scheme, a hardware structure, and the like of the mobile communication device 62 are the same as those of the mobile communication device 5 of the client CLT.

In the foregoing description, the collection/delivery box device 1 and the home server 2 constitute the client server system in the home network, and the home server 2 generates request information and manages information relating to collection/delivery such as the issuance of personal identification number. However, the collection/delivery box device 1 may be of a stand-alone type to perform all the processing.

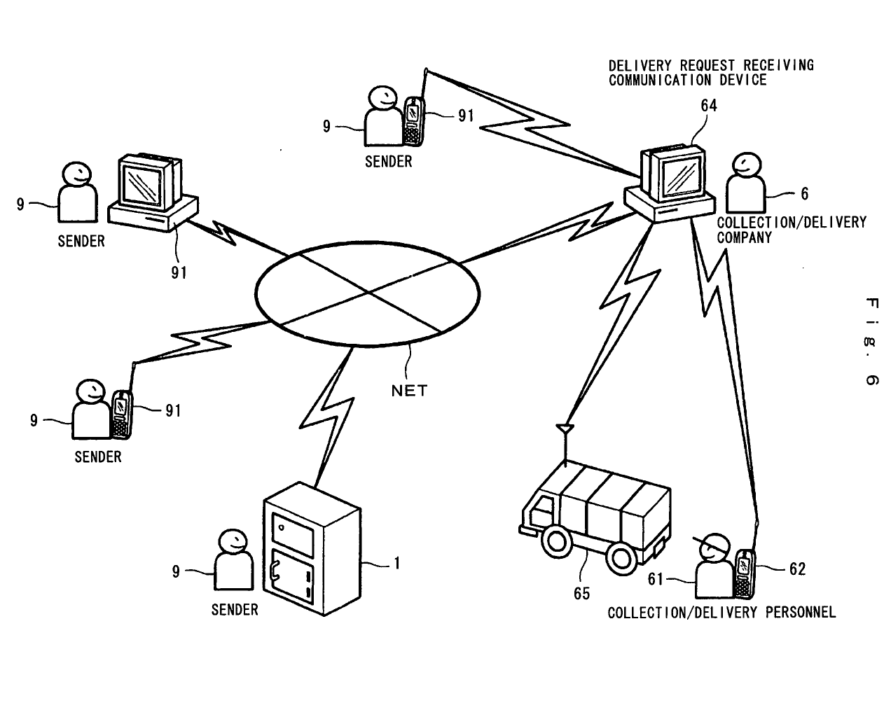

By the way, other than the case where the collection and/or delivery is/are originated from the request from the client CLT, the collection and/or delivery is/are performed in the cases where the client CLT orders merchandise from a mail order company, an acquaintance of the client CLT sends a gift to the client CLT, and so forth. In these cases, as shown in FIG. 6, a sender 9 such as the mail order company and the acquaintance of the client CLT uses any one of various communication devices 91 such as a network compatible cellular phone and a personal computer or the collection/delivery box device 1 to send a request to the delivery request receiving communication device 64 operated by the collection/delivery company 6 which is a destination of the delivery request. The sender 9 sends delivery request information generated by the communication device 91 to the delivery request receiving communication device 64 directly or indirectly via the network NET.

The collection/delivery company 6 uses the delivery request receiving communication device 64 to transfer the delivery request information (the delivery request information includes a personal identification number which will be described later in this specification) to the collection/delivery personnel 61 at job site who is in charge of the area of a receiver's home. The collection/delivery personnel 61 receives the delivery request information using an on-vehicle communication device mounted on the collection/delivery car 65 or the mobile communication device 62. The on-vehicle communication device may be so constructed as to download the transferred delivery request information to the mobile communication device 62. Of course, the delivery request from the sender 9 may be received directly by the collection/delivery personnel 61 at job site, but, in actuality, it is desirable that the processing relating to receipt of delivery request is centrally administered by the delivery request receiving communication device 64

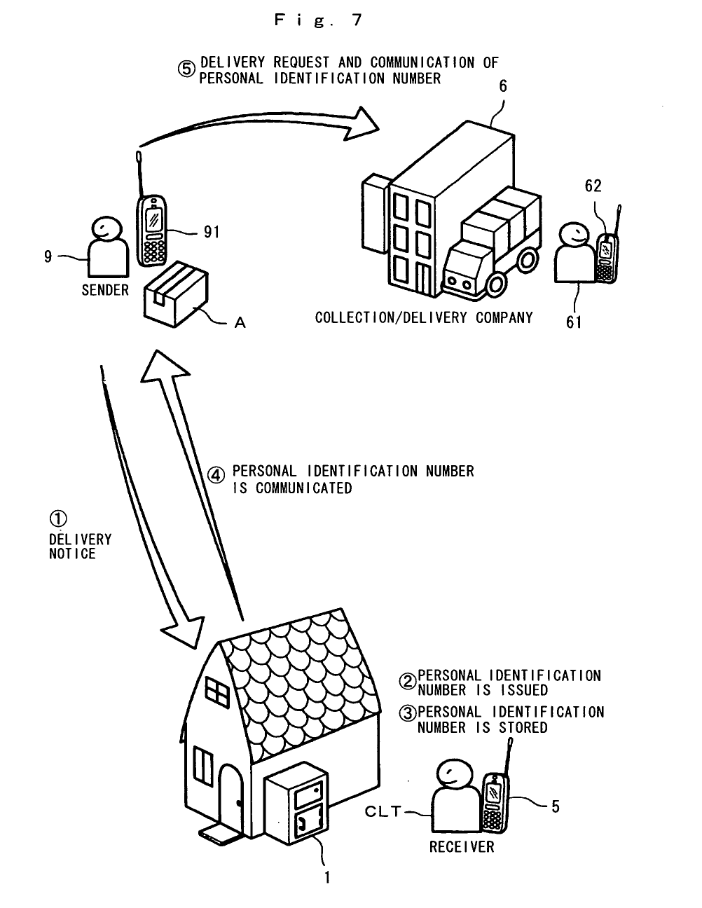

Hereinafter, a process of issuing the personal identification number accompanying the delivery request will be described with reference to FIGS. 7 to 16. In the following, it is desirable that each of the receiver (client CLT), the sender 9, and the collection/delivery company 6 performs information processing using his/her communication devices. More specifically, the receiver uses the collection/delivery box device 1, the home server 2, the mobile communication device 5, and so forth; the sender 9 uses the communication device 91, the collection/delivery box device 1, and so forth; and the collection/delivery company 6 uses the delivery request receiving communication device 64, the mobile communication device 62 of the collection/delivery personnel 61, and the collection/delivery car 65 (or, strictly speaking, the on-vehicle communication device), and so forth.

As shown in FIG. 7, the sender 9 gives a delivery notice of an article A to the client CLT who is the receiver in advance of making a request to the collection/delivery company 6 for delivery (Step 1). In the case where the receiver receives and accepts the delivery notice, the receiver issues a personal identification number (Step 2) and stores the issued personal identification number in the collection/delivery box device 1 (Step 3). The receiver informs the sender 9 of the personal identification number stored in the collection/delivery box device 1 together with information indicating the acceptance of delivery (Step 4). After receiving the personal identification number, the sender 9 makes the delivery request to the collection/delivery company 6 simultaneously with giving the personal identification number to the collection/delivery company 6 (Step 5).

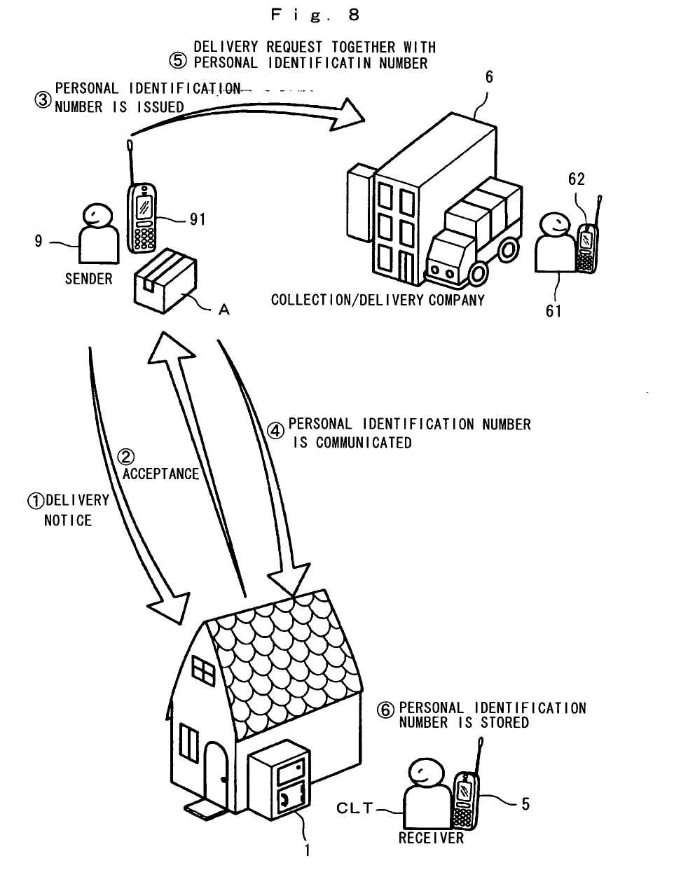

As shown in FIG. 8, in the case where the sender 9 gives a delivery notice of an article A to the client who is the receiver in advance of making a delivery request to the collection/delivery company 6 (Step 1), the receiver, after receiving the delivery notice, may inform the sender 9 only of the acceptance of delivery without issuing a personal identification number (Step 2). After receiving the information, the sender 9 issues a personal identification number (Step 3) and informs the receiver of the personal identification number (Step 4). The sender 9 makes the delivery request to the collection/delivery company 6 (Step 5) at the same time with informing the receiver of the personal identification number. The receiver stores the personal identification number informed by the sender 9 in the collection/delivery box device 1 (Step 6).

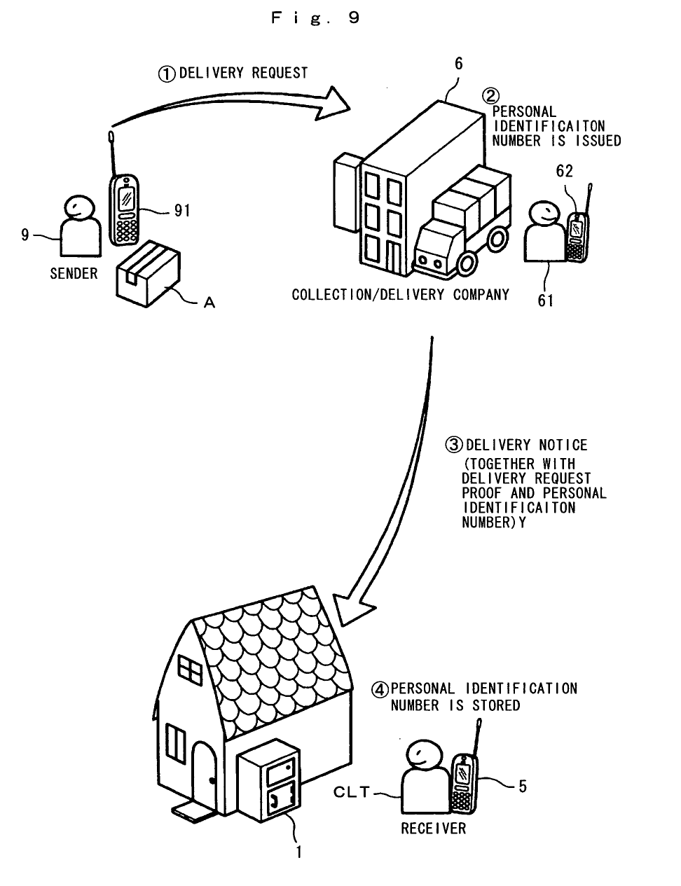

As shown in FIG. 9, in the case where the collection/delivery company 6 issues a personal identification number, the sender 9 makes a delivery request to the collection/delivery company 6 to start with (Step 1). After receiving the delivery request, the collection/delivery company 6 issues a personal identification number (Step 2) and gives a delivery notice to the receiver (Step 3). The delivery notice includes information that the delivery request has been sent form the sender 9, information for proving that the collection/delivery company 6 is the true collection/delivery company who has received the delivery request from the sender 9 (hereinafter referred to as “delivery request proof”), and the personal identification number. After receiving the delivery notice, the receiver stores the personal identification number included in the delivery notice in the collection/delivery box device 1 (Step 4).

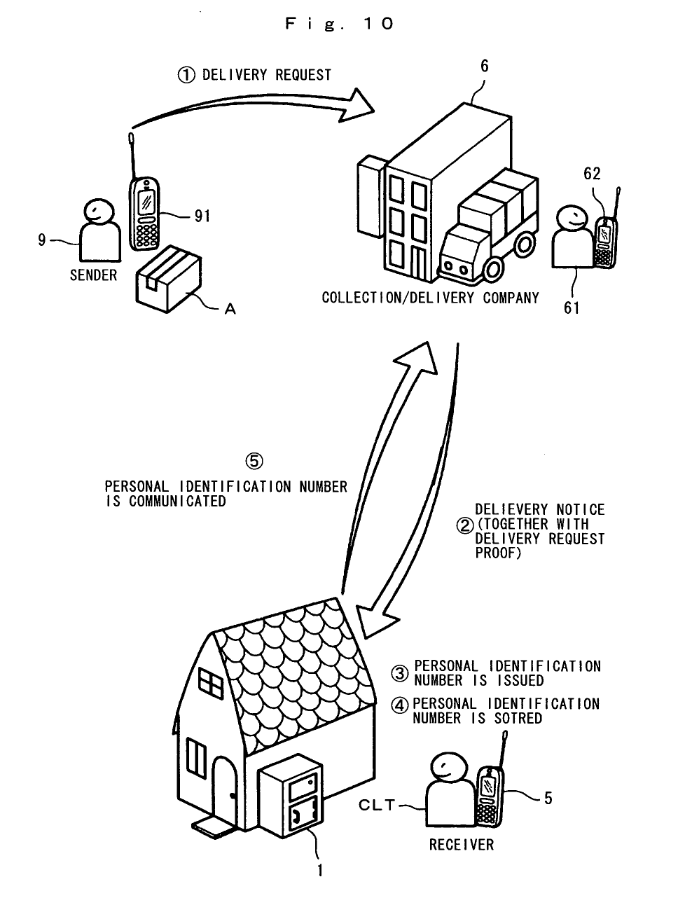

Likewise, as shown in FIG. 10, the sender 9 makes a delivery request to the collection/delivery company 6 (Step 1), and, after receiving the delivery request, the collection/delivery company 6 sends a delivery notice to the receiver (Step 2). The delivery notice includes a delivery request proof, but does not include any personal identification number. The receiver issues a personal identification number after receiving the delivery notice (Step 3) to store the personal identification number in the collection/delivery box device 1 (Step 4).

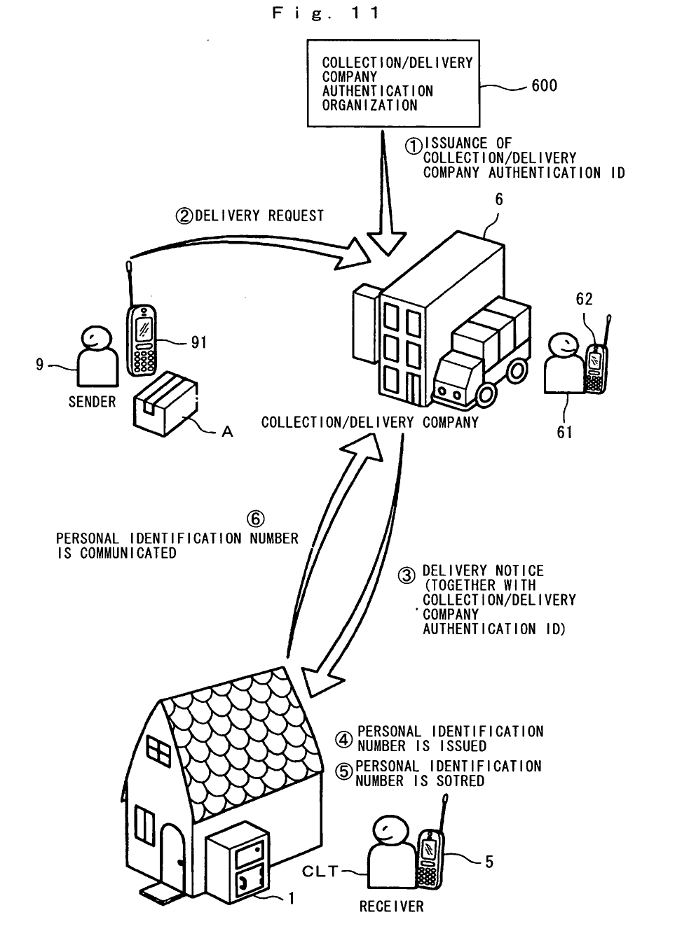

As shown in FIG. 11, a collection/delivery company authentication organization 600 may be established beforehand. The collection/delivery company authentication organization 600 at least authenticates that the collection/delivery company 6 is the true collection/delivery company to issue information confirming the authenticity (hereinafter referred to as “collection/delivery company authentication ID) (Step 1). Owing to the collection/delivery company authentication ID, reliability of a delivery notice given from the collection/delivery company 6 to the receiver is increased. When the collection/delivery company 6 receives a delivery request from the sender 9 (Step 2), the collection/delivery company 6 gives a delivery notice including the collection/delivery company authentication ID to the receiver (Step 3). After receiving the delivery notice, the receiver issues a personal identification number (Step 4). The issued personal identification number is stored in the collection/delivery box device 1, and, simultaneously, the collection/delivery company 6 (Step 6) is informed of the personal identification number.

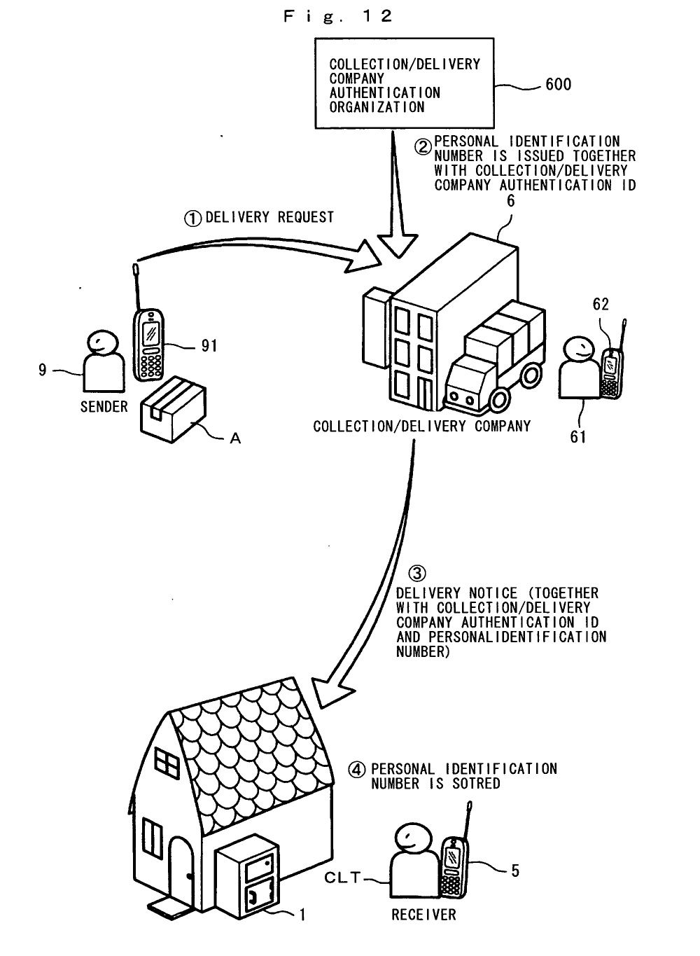

As shown in FIG. 12, the collection/delivery company authentication organization 600 may issue the collection/delivery company authentication ID for each of delivery requests. In this case, the collection/delivery company authentication organization 600, for example, may issue a personal identification number. More specifically, when the collection/delivery company 6 receives a delivery request (Step 1) from the sender 9, the collection/delivery company 6 then receives a collection/delivery company authentication ID and a personal identification number for the delivery request from the collection/delivery authentication organization 600 (Step 2). Here, the collection/delivery company authentication ID may be specific to the delivery request. Upon issuance of the personal identification number with the collection/delivery authentication ID, the collection/delivery company 6 gives a delivery notice to the receiver (Step 3). The delivery notice includes the personal identification number with the collection/delivery company authentication ID. After receiving the delivery notice, the receiver stores the personal identification number in the collection/delivery box device 1 (Step 4).

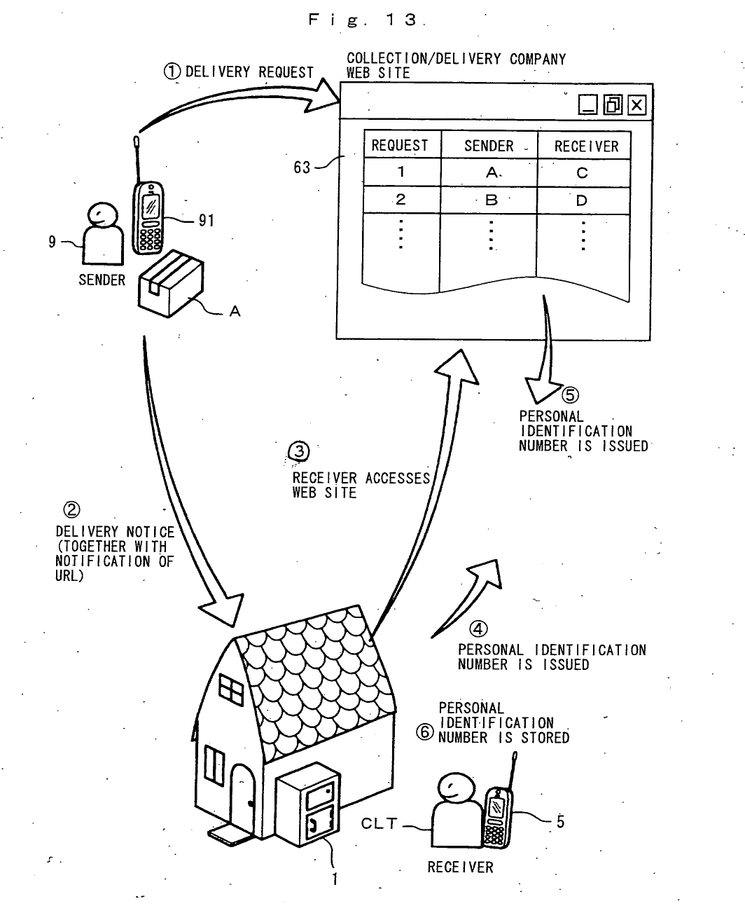

As shown in FIG. 13, a web site 63 operated by the collection/delivery company may serve as the collection/delivery company 6. In this case, the collection/delivery company web site 63 has functions of receiving and managing delivery requests, issuance of personal identification numbers, and so forth. For instance, the collection/delivery company web site 63 bears various delivery request information such as a management number of a received request, information relating to the sender 9 who made the request (name, address, phone number, item of delivery, etc.), and information relating to the receiver (name, address, phone number, etc.). The sender 9 may write the delivery request information on the collection/delivery company web site 63. The receiver confirms the delivery request information and receives the personal identification number by the use of the collection/delivery company web site 63.

More specifically, the sender 9 accesses the collection/delivery company web site 63 to make a delivery request on the web site 63 (Step 1). After completion of the delivery request, information described above is inserted on the collection/delivery company web site 63 as one delivery request. The sender 9 uses a web page for e-male transmission, for example, which constitutes a part of the collection/delivery company web site 63, to send e-mail to the receiver, thereby giving a delivery notice to the receiver (Step 2).

The e-mail sent to the receiver includes the URL, for example, of the collection/delivery company web site 63, and the receiver who receives the e-mail can access the collection/delivery company web site 63 easily by pointing the URL (Step 3). After accessing the collection/delivery company web site 63, the receiver confirms that the delivery request corresponding to the delivery notice sent to the receiver is inserted on the collection/delivery company web site 63. The receiver issues a personal identification number in accordance with instructions included in the collection/delivery company web site 63 to send the personal identification number to the collection/delivery company web site 63 (Step 4). Alternatively, the collection/delivery company web site 63 may issue the personal identification number, so that the receiver receives the personal identification number in accordance with instructions of the collection/delivery company web site (Step 5). The receiver stores the personal identification number in the collection/delivery box device 1 (Step 6).

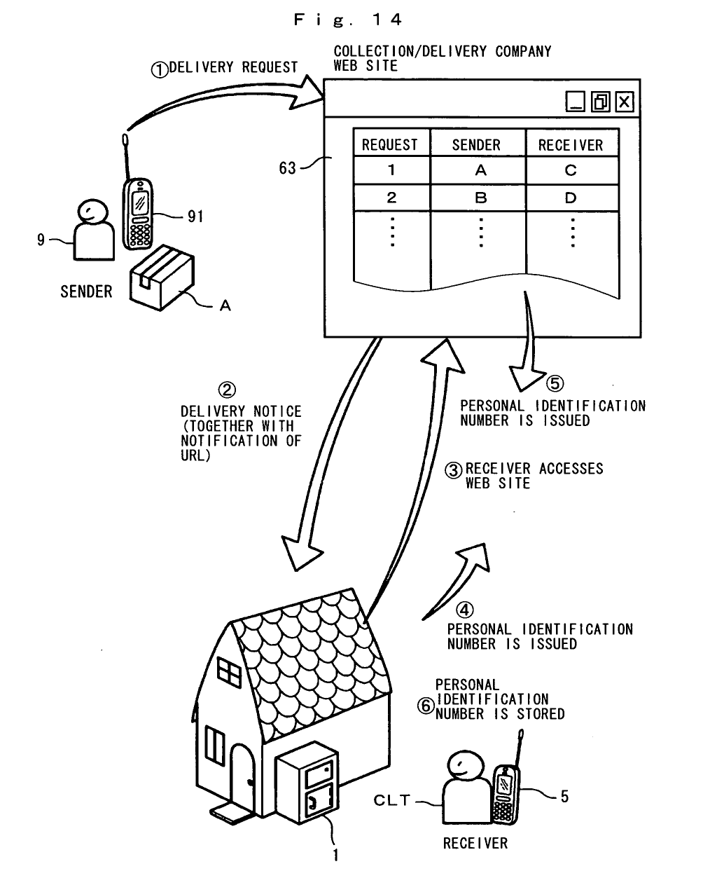

As shown in FIG. 14, the collection/delivery company web site 63 automatically gives a delivery notice to the receiver in place of the sender 9. That is, the sender 9 accesses the collection/delivery company web site 63 to make a delivery request on the collection/delivery company web site 63 (Step 1). After completion of the delivery request, the information relating to the delivery request is inserted on the collection/delivery company web site 63 as one delivery request. The collection/delivery company web site 63 sends e-mail including the URL thereof to the receiver as a delivery notice (Step 2).

The receiver accesses the collection/delivery company web site 63 corresponding to the URL included in the e-mail (Step 3) to issue a personal identification number. Alternatively, the collection/delivery web site 63 may issue the personal identification number (Steps 4 and 5). The receiver stores the personal identification number in the collection/delivery box device 1 (Step 6).

In this embodiment, the receiver and the collection/delivery company uses the identical key information for releasing the lock on the collection/delivery box device 1. That is, the common key scheme is employed in this embodiment. However, the asymmetric key scheme using two types of key information may be employed in place of the common key scheme.

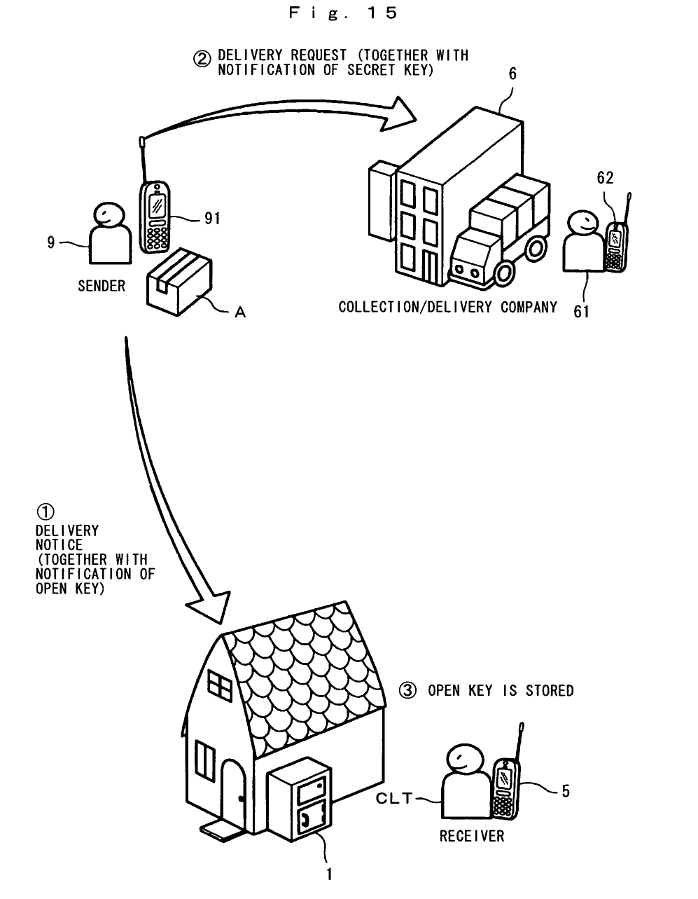

For instance, as shown in FIG. 15, the sender 9 issues an open key and gives a delivery notice including the open key to the receiver (Step 1). The sender 9 issues a secret key and makes a delivery request including the secret key to the collection/delivery company 6 (Step 2). The receiver stores the open key included in the delivery notice from the sender 9 in the collection/delivery box device 1.

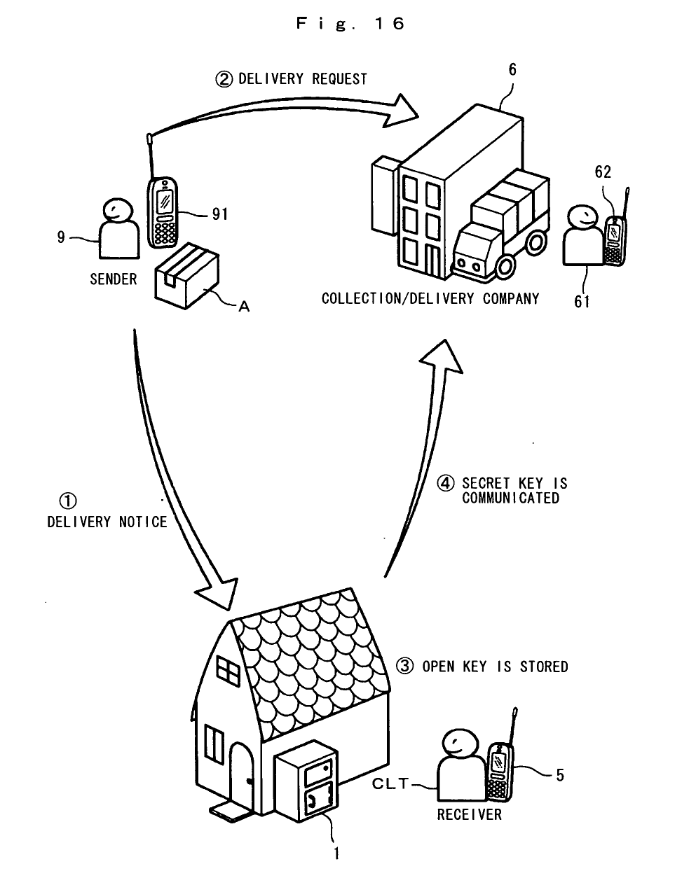

Likewise, as shown in FIG. 16, the sender 9 gives a delivery notice to the receiver (Step 1) at the same time with requesting the collection/delivery company 6 of a delivery (Step 2). After receiving the delivery notice, the receiver issues an open key and a secret key and stores the open key in the collection/delivery box device 1 (Step 3) simultaneously with giving the secret key to the collection/delivery company 6 (Step 4).

As described in the above two modes of this embodiment, the open key held by the receiver is stored in the collection/delivery box device 1, while the secret key held by the collection/delivery company 6 is used for encoding information such as the delivery request. The encoded information is, for example, transferred from the delivery request receiving communication device 64 to the mobile communication device 62 of the collection/delivery personnel 61 at job site. The encoded information is temporarily held by the mobile communication device 62 and then sent from the mobile communication device 62 to the collection/delivery box device 1 by an appropriate communication means. Thus, the encoded information is stored in the collection/delivery box device 1. The collection/delivery box device 1 decodes the encoded information using the open key. When the encoded information is decoded, the lock is released. In order to improve the security, another authentication may be required for the decoding. Thus, the key information is not necessarily be key information itself such as the personal identification number and may be the information encoded by the use of the key. Further, the key information may be created by using a security scheme such as a digital ID, an electronic signature, and the like.

The use of the collection/delivery box device 1 is not limited to the receiver's use, and the sender may use the collection/delivery box device 1 for the purpose of having an article collected. Therefore, it is possible for both of the receiver and the sender to use the collection/delivery box device 1.

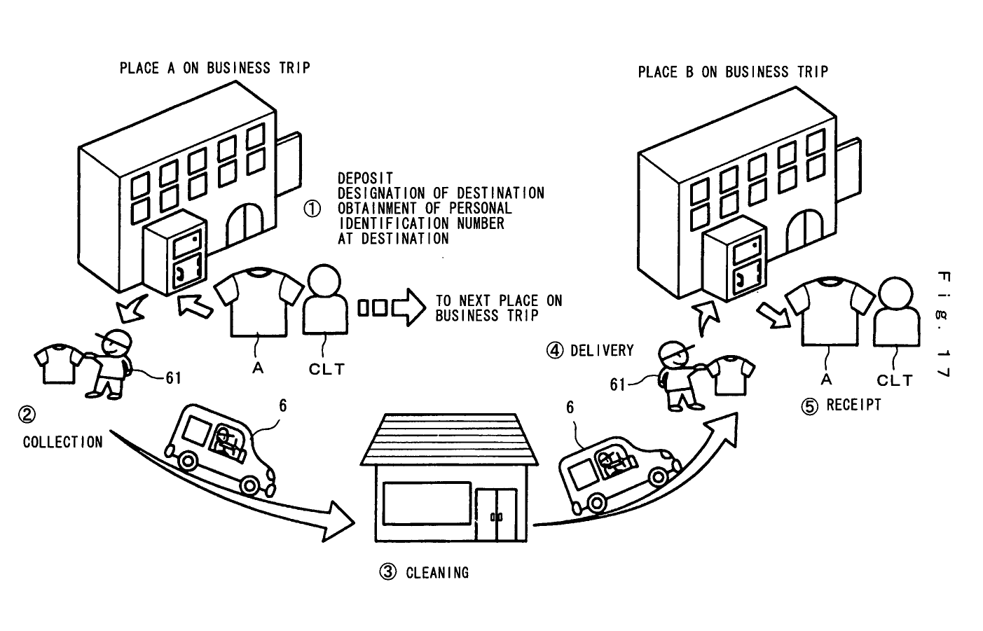

From the above point of view, as shown in FIG. 17, in the case where a certain client CLT stays at a certain place A (ex. hotel) on a business trip and deposits a laundry item as an article A in a collection/delivery box device installed at the place A (Step 1), for instance, the client CLT designates a destination using the collection/delivery box device 1 and obtains a personal identification number from the collection/delivery box device 1. In this case, it is desirable that the collection/delivery box device 1 is provided with an appropriate input means.

In the case where the client CLT designates a place B (ex. another hotel) to be visited subsequently on the business trip as the destination, the collection/delivery company 6 collects the article A deposited in the collection/delivery box device 1 (Step 2) to deliver the article A to a laundry company. The article A undergoes a cleaning service, for example, of the laundry company (Step 3) and then delivered to the collection/delivery box device 1 at the destination which is the place B (Step 4). When the client CLT arrives at the place B, the client CLT takes out the article A after cleaning from the collection/delivery box device 1 installed at the place B by using the personal identification number (Step 5).

The above case is described only by way of example. Since the collection/delivery box device 1 of the invention uses the transmittable key information, various other embodiments are realized by using plural collection/delivery box devices 1. Therefore, the use of the collection/delivery box device 1 is not limited to the laundry service and may be used for a simple delivery service. It is also possible to realize an embodiment wherein a person acts as the sender and receiver and uses plural collection/delivery box devices 1. Further, a single collection/delivery box device 1 may be installed at a public space such as a station to be used by the sender and the receiver as a common locker.

### Industrial Applicability

According to the present invention, a client does not necessarily stay at home for a delivery and/or collection, and a place of delivery/collection can be located as close as possible to the client's home, thereby freeing a collection/delivery company from worrying whether the client is at home or not.

According to the invention, key information of high security is issued for releasing the lock on the collection/delivery box device, and the collection/delivery company obtains the key information with the high security being maintained. Moreover, the client and the collection/delivery company do not have to perform complicated operation.

According to the invention, thanks to the use of the key information of high security, the client and the collection/delivery company conveniently release the lock on the collection/delivery box device.

1. A method for obtaining and issuing key information of a collection/delivery box device, by which a collection/delivery company obtains electronic key information to be used for releasing a lock on a door of a collection/delivery box device of a receiver and putting an article in the collection/delivery box device in response to a delivery request made by a sender to the collection/delivery company, wherein
the sender gives a delivery notice of the article to the receiver, and the receiver or the sender issues the key information;
the key information is given to the receiver in the case where the receiver issues the key information, while the key information is given to the receiver and the collection/delivery company in the case where the sender issues the key information; and
at least one of the receiver, the sender, and the collection/delivery company performs the issuance or the communication of the key information by using a mobile communication device which is capable of close wireless communication of the key information.

2. A method for obtaining and issuing key information of a collection/delivery box device, by which a collection/delivery company obtains electronic key information to be used for releasing a lock on a door of a collection/delivery box device of a receiver and putting an article in the collection/delivery box device in response to a delivery request made by a sender to the collection/delivery company, wherein
the collection/delivery company who received the delivery request of the article from the sender gives a delivery notice of the article to the receiver, and the sender or the collection/delivery company issues the key information;
the key information is given to the receiver and the collection/delivery company in the case where the sender issues the key information, while the key information is given to the receiver in the case where and the collection/delivery company issues the key information; and
at least one of the receiver, the sender, and the collection/delivery company performs the issuance or the communication of the key information by using a mobile communication device which is capable of close wireless communication of the key information.

3. The method for obtaining and issuing key information of a collection/delivery box device according to claim 2, wherein
at least one of information specifying the sender and information specifying the collection/delivery company is included in the delivery notice in the case where the sender or the collection/delivery company issues the key information.

4. The method for obtaining and issuing key information of a collection/delivery box device according to claim 3, wherein,
in the case where the information specifying the sender or the information specifying the collection/delivery company is included in the delivery notice,
the information includes information that the sender or the collection/delivery company has been authenticated by a predetermined authentication organization.

5. The method for obtaining and issuing key information of a collection/delivery box device according to claim 1, wherein
the key information includes two types of information of first key information and second key information;
the receiver holds the first key information; and
the sender or the collection/delivery company uses the second key information to encode information specifying the sender or information specifying the collection/delivery company.
